(19) United States
(12) Patent Application Publication
(10) Pub. No.: US 2010/0324459 A1
(43) Pub. Date: Dec. 23, 2010

(54) CARDIAC SHOCK WAVE MEDICAL INSTRUMENT

(76) Inventor: Raymond Law, Hong Kong (CN)

Correspondence Address: PERKINS COIE LLP, POST OFFICE BOX 1208, SEATTLE, WA, 98111-1208, US

(21) Appl. No.: 12/376,287

(22) PCT Filed: Jul. 20, 2007
(86) PCT No.: PCT/CN07/02209

§ 371 Date: Nov. 30, 2009

(30) Foreign Application Priority Data
Aug. 3, 2006 (CN) 200610109189.3

(51) Int. Cl. A61H 1/00

(52) U.S. Cl. 601/47

(57) ABSTRACT

The invention provides a cardiac shock wave medical instrument characterized in comprising a contact microphone, a central processing unit, a centralized production control unit, a full audio range amplifier and a representative super-broad audio range sounder; a terminal of the contact microphone is connected with an input terminal of the central processing unit, an output terminal of the central processing unit is connected with an input terminal of the centralized production control unit, an output terminal of the centralized production control unit is connected with an input terminal of the full audio range amplifier, an output terminal of the full audio range amplifier is connected with an input terminal of the super-broad audio range sounder, and the super broad audio range sounder works at corresponding position of a treated part. The invention also provides a method for using the cardiac shock wave medical instrument.

### FIELD OF THE INVENTION

Generally speaking, the invention relates to a medical instrument, in particular, a cardiac shock wave medical instrument.

### BACKGROUND OF THE INVENTION

When a man's heart beats, it definitely emits heart beating shock-acoustic waves, which is called cardiac shock waves for short. These cardiac shock waves, which comprise motile shock forces of different frequencies and sound wavelengths of different decibels, are very complicated multiplex shock wave energies. Besides, these heart beating shock-acoustic waves, i.e., the frequencies and the wavelengths of the cardiac shock waves, change slightly to different extents every time the heart beats.

### SUMMARY OF THE INVENTION

The inventor finds that once the same kind of cardiac shock waves are effectively introduced from opposite directions respectively and converged at a focus point, wherein the area of the focus point may be large or small, the cardiac shock waves will produce tiny energy explosions at different force levels when these waves meet at the focus point because of the front collision of the same frequencies, wavelengths and volumes. Even if the force is weakened to only a few percent of the original cardiac shock wave, it is strong enough to tear/break the vital protection outer membrane of a cell so as to kill germs and cancer cells once it focuses on the germs and the cancer cells in the aspect of microorganism. It is also effective to the fungus cells with the strongest cell wall membrane. However, the healthy and intact cells of all human organs would not be affected at all, since the outer wall membranes of the healthy cells in the human body are congenitally adaptive to the frequency, wavelength and volume of the cardiac shock wave emitted from the heart, as well as to the multiple values of these energies.

The inventor also finds that components of the material and structural properties such as thickness, thinness and stretch levels of the wall membrane of any healthy cell in the human body are innate and fully adaptive to series of combinations of the cardiac shock waves. While the nature of these cell wall membranes is determined by genes (DNA) within the chromosomes. However, as to those human cells whose nature or components are pathologically changed due to either mutation of genes or external poisonous factors, such as the cancerous cells, the thickness and structure of their cell wall membranes would change to different extents, consequently, the cardiac shock wave which was safe before to the healthy cells becomes deadly sound boom to those cancerous cells instantly.

One objective of the invention is to provide a novel cardiac shock wave medical instrument.

The other objective of the invention is to provide a method for using the innovational cardiac shock wave medical instrument.

In one aspect of the invention, the cardiac shock wave medical instrument is characterized in comprising a contact microphone, a central processing unit, a centralized production control unit, a full audio range amplifier and a super-broad audio range sounder;

a terminal of the contact microphone is connected with an input terminal of the central processing unit, an output terminal of the central processing unit is connected with an input terminal of the centralized production control unit, an output terminal of the centralized production control unit is connected with an input terminal of the full audio range amplifier, an output terminal of the full audio range amplifier is connected with an input terminal of the super-broad audio range sounder, while the super-broad audio range sounder works at corresponding position of a treated part.

In another aspect of the invention, the method for using the cardiac shock wave medical treatment comprises following steps:

applying two contact microphones at the diagonal positions on two sides of the treated target part;
pressing slightly the sounder onto the surface of the treated part;
controlling the full audio range amplifier and the super-broad audio range sounder by the centralized production control unit to produce cardiac shock waves whose frequencies, wavelengths and volumes are as the same as those of a treated object's cardiac shock waves;
converging directly and externally the cardiac shock wave with the cardiac shock wave coming from interiors of a man's veins and bones at an focus, so as to kill germs and cancer effectively.

### DESCRIPTION OF THE DRAWINGS

FIG. 1 shows the first embodiment for the cardiac shock wave medical instrument of the invention;

FIG. 2 shows the second embodiment for the cardiac shock wave medical instrument of the invention, and

FIG. 3 shows the third embodiment for the cardiac shock wave medical instrument of the invention.

### DETAILED DESCRIPTION OF THE INVENTION

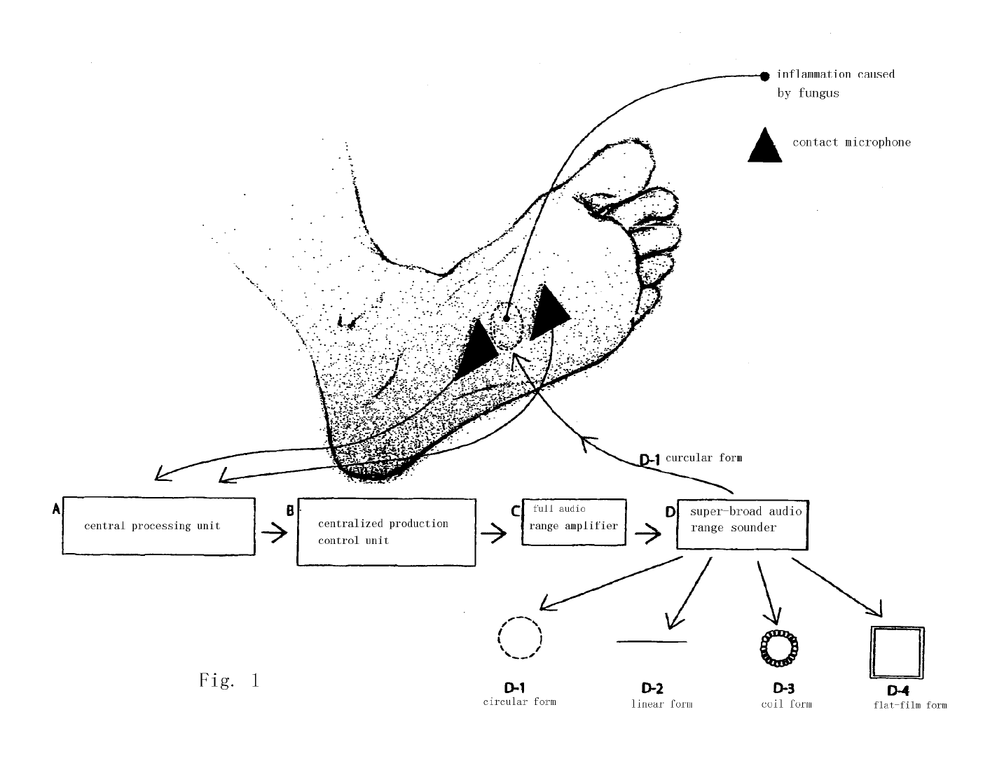

Now, the preferred embodiments are described with reference to the drawings. The same sign represents the same device, such as Δ represents a high-sensitivity contact microphone, A represents a microprocessor, B represents a centralized production control unit, C represents a full audio range amplifier, and D represents a super-broad audio range sounder. As illustrated in FIGS. 1 to 3, the cardiac shock wave medical instrument of the invention comprises following devices:

1. a high-sensitivity contact microphone;
2. a microprocessor, which is able to analyze and process frequency/force of the cardiac shock wave and wavelength/decibel of sound, being served as a central processing unit;
3. a personal computer with exclusive high-performance for setting up the shock wave and sound wave of the software/constituent means, being served as centralized production control unit for controlling the amplifier and sounder to produce the desired cardiac shock wave identical with that of the treated object;
4. a full audio range amplifier and a super-broad audio range sounder which is also called a loud speaker, duplicating the full cardiac shock wave frequency, wavelength and volume; the super-broad audio range sounder comprising a series of sounders in plural modes and shapes, which are such as circular form shown as D-1, linear form shown as D-2, coil form shown as D-3 or flat-film form shown as D-4 in FIGS. 1 to 3;
5. various supporting devices such as connection wires, sockets and drives, wherein the drives comprising motor drives and acoustic drives;
6. fixed carrier and scanner in different sizes;
7. movable carrier and scanner in human size.

As shown in FIGS. 1 to 3, a terminal of the contact microphone Δ is connected with an input terminal of the central processing unit A, an output terminal of the central processing unit A is connected with an input terminal of the centralized production control unit B, an output terminal of the centralized production control unit B is connected with an input terminal of the full audio range amplifier C, an output terminal of the full audio range amplifier C is connected with an input terminal of the super-broad audio range sounder D, and the super-broad audio range sounder D works at corresponding position of the treated part.

Besides, the supporting devices, size and construction complexity of each set of the application apparatus depend on the part and the area of the human body to which the apparatus is applied, for instance, the apparatus is applied on a local circular surface portion of the body with diameter less than one millimeter, or on a portion so large that the whole body scanning is required, hence all those applications need different supporting devices.

FIG. 1 shows the first embodiment for the cardiac shock wave medical instrument of the invention, which is applied to small shallow fixed target portion on the surface of a man's limbs:

Applying, at the small portion such as a wound or a tumor where germs and cancer are to be killed, two microphones at the diagonal positions on two sides of the treated target, wherein one microphone is placed on the side close to the heart while the other one is placed on the side away from the heart.

The two microphones are connected sequentially to the central processing unit and the centralized production control unit, and then to the amplifier's supporting devices.

In this regard, a circular sounder with diameter of 1.5 centimeters is adequate. A circular sounder is slightly applied to the surface of a treated target, and initiated several times for four to ten minutes or above, then the cardiac shock wave which is precisely duplicated is directly and externally converged with the cardiac shock wave coming from interior of a man's veins and bones at a focus, in this way, germs and cancer are killed effectively.

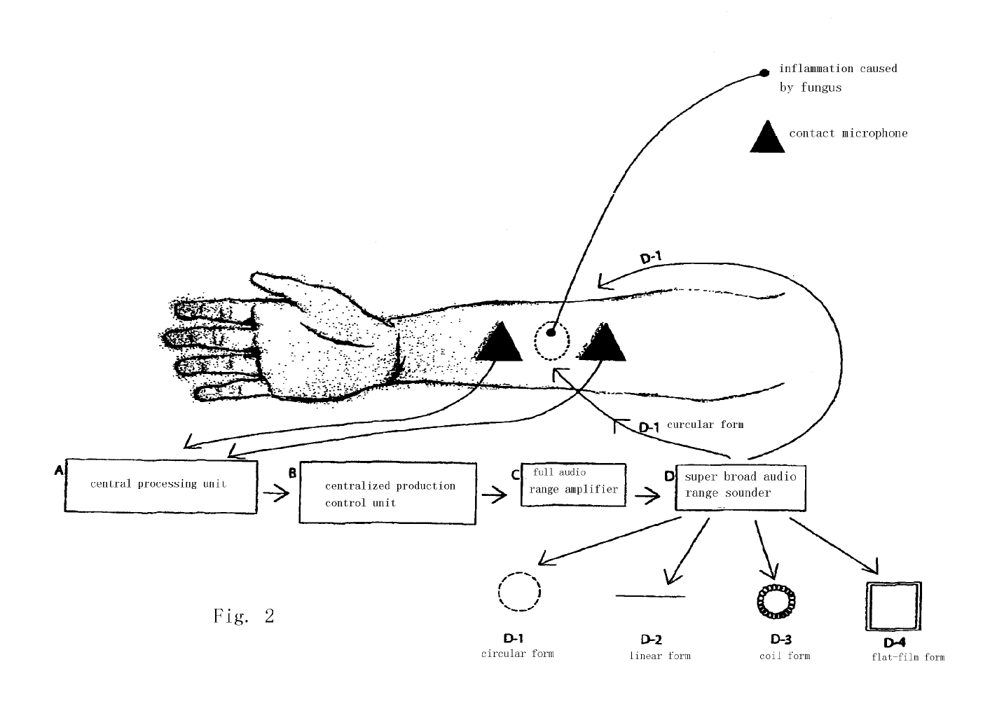

FIG. 2 shows the second embodiment for the cardiac shock wave medical instrument of the invention, which is adaptive to limbs, the human body or other small deep fixed targets.

The circuitry portion of the cardiac shock wave medical instrument shown in FIG. 2 is substantially identical with that shown in FIG. 1, while two sounders with larger diameter or in other shapes are required; the sounders are placed opposite to each other with a treated target portion being placed therebetween; accordingly, the working times for the sounders are increased proportionally.

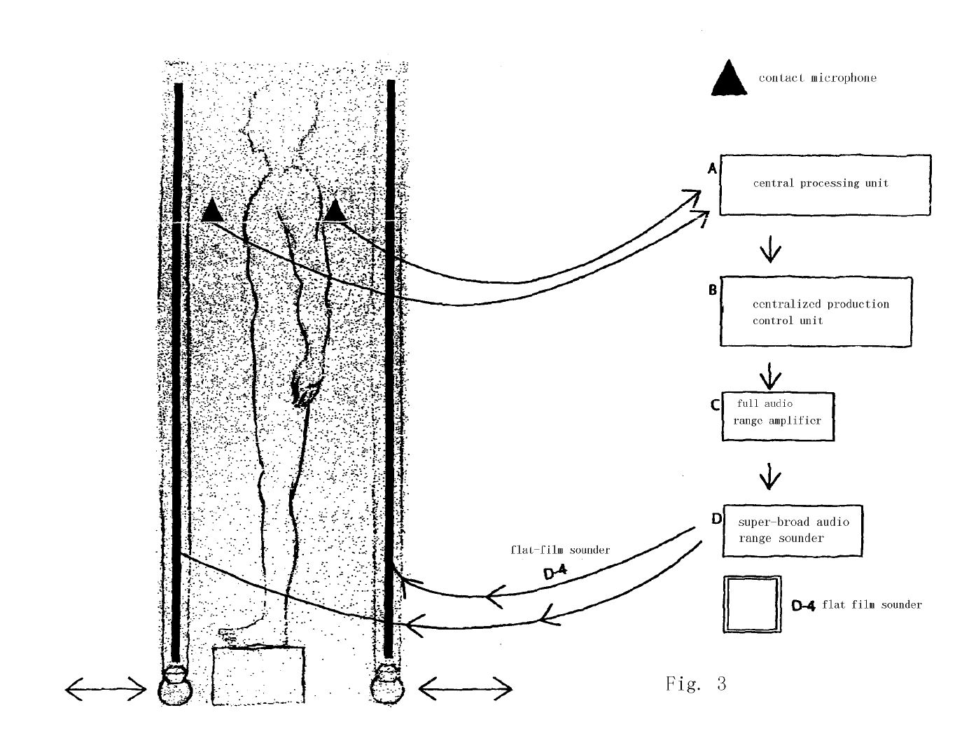

FIG. 3 shows the cardiac shock wave medical instrument of the invention, which is adaptive to a deeper and floating target portion to be treated, such as blood or lymph. The circuitry portion of the cardiac shock wave medical instrument shown in FIG. 3 is substantially identical with that shown in both FIG. 1 and FIG. 2.

In this regard, a cardiac shock wave convergent means is required, and a motor drive is mounted at the bottom of the cardiac shock wave convergent means so as to make the same move forward and backward. The cardiac shock wave convergent means comprises at least two flat-film sounders high and broad enough to cover the whole human body. Acoustic drives are mounted on the flat-film sounders, which are placed upright and opposite to each other on the scanning platform able to move forward and backward. The subject to be treated stands on the fixed platform between the two flat-film sounders, and then the cardiac shock wave convergent means moves forward and backward, so that every cubic millimeter of the whole body can be scanned. Accordingly, the working times of the flat-film sounders are adjusted proportionally.

Although foregoing text already describes several embodiments for the cardiac shock wave medical instrument of the invention in detail, these embodiments are illustrative only. The protection scope of the invention is not limited to the specific embodiments described herein, but rather to the scope of the claims attached hereto.

1. A cardiac shock wave medical instrument comprising a contact microphone, a central processing unit, a centralized production control unit, a full audio range amplifier and a representative super-broad audio range sounder, wherein:
a terminal of the contact microphone is connected with an input terminal of the central processing unit;
an output terminal of the central processing unit is connected with an input terminal of the centralized production control unit;
an output terminal of the centralized production control unit is connected with an input terminal of the full audio range amplifier;
an output terminal of the full audio range amplifier is connected with an input terminal of the super-broad audio range sounder; and
the super-broad audio range sounder works at a corresponding position of a treated part of a treated object.

2. The cardiac shock wave medical instrument according to claim 1, wherein the central processing unit comprises a microprocessor with proprietary application software.

3. The cardiac shock wave medical instrument according to claim 1, wherein the centralized production control unit comprises a personal computer with proprietary application software.

4. The cardiac shock wave medical instrument according to claim 1, wherein the super-broad audio range sounder is a loud speaker.

5. The cardiac shock wave medical instrument according to claim 1, wherein the super-broad audio range sounder is a circular super-broad audio range sounder, a linear super-broad audio range sounder, a coil super-broad audio range sounder or a flat-film super-broad audio range sounder.

6. The cardiac shock wave medical instrument according to claim 5, wherein the super-broad audio range sounder is a circular super-broad audio range sounder with a diameter of 1.5 centimeters.

7. The cardiac shock wave medical instrument according to claim 1, wherein the centralized production control unit controls the full audio range amplifier and super-broad audio range sounder to produce a cardiac shock wave with the same frequency, wavelength and volume as those of the treated object's cardiac shock wave.

8. The cardiac shock wave medical instrument according to claim 1 comprising two contact microphones.

9. The cardiac shock wave medical instrument according to claim 1, wherein the super-broad audio range sounder comprises at least two flat-film sounders that are high and broad enough to cover the whole body of the treated object, and the flat-film sounders are placed upright and opposite to each other on a scanning platform which allows the flat-film sounders to move forward and backward for full body scanning convergence.

10. The cardiac shock wave medical instrument according to claim 9, further comprising a cardiac shock wave convergent means able to move forward and backward.

11. The cardiac shock wave medical instrument according to claim 1, further comprising drives.

12. The cardiac shock wave medical instrument according to claim 11, wherein the drives comprise motor drives and acoustic drives.

13. A method for using a cardiac shock wave medical instrument according to claim 8 comprising the following steps:
applying two contact microphones at diagonal positions on two sides of the treated part of the treated object;
pressing slightly the sounder onto the surface of the treated part;
controlling the full audio range amplifier and the super-broad audio range sounder by the centralized production control unit, so as to produce a cardiac shock wave with the same frequencies, wavelengths and volumes as those of the treated object's cardiac shock wave; and
directly converging the external cardiac shock wave with the internal cardiac shock wave coming from the treated object's arteries/veins and bones to a focus so as to kill germs and cancer effectively at the focus.

14. The method for using a cardiac shock wave medical instrument according to claim 13, wherein one of the two contact microphones is placed on a side closer to the heart of the treated object, and the other contact microphone is placed on a side further away from the heart of the treated object.

15. A method for using a cardiac shock wave medical instrument according to claim 13, wherein the working time of the sounder is adjusted correspondingly based on the depth of the treated part in the treated object.

16. A method for using a cardiac shock wave medical instrument according to claim 13, wherein the sounder is turned on and off several times, and each time the sounder is on for four to ten minutes or as long as deemed necessary.

17. (canceled)

18. A method for using a cardiac shock wave medical instrument according to claim 9, comprising the following steps:
applying two contact microphones at diagonal positions on two sides of the treated part of the treated object;
pressing slightly the sounder onto the surface of the treated part;
controlling the full-audio range amplifier and the super-broad audio range sounder by the centralized production control unit, so as to produce a cardiac shock wave with the same frequencies, wavelengths and volumes as those of the treated object's cardiac shock wave; and
directly converging the external cardiac shock wave with the internal cardiac shock wave coming from the treated object's arteries/veins and bones to a focus so as to kill germs and cancer effectively at the focus.

19. The method for using a cardiac shock wave medical instrument according to claim 18, wherein the working time of the sounder is adjusted correspondingly based on the depth of the treated part in the treated object.

20. The method for using a cardiac shock wave medical instrument according to claim 18, wherein the sounder is turned on and off several times, or as many times as deemed necessary, and each time the sounder is on for four to ten minutes or as long as deemed necessary.

21. The method for using the cardiac shock wave medical instrument according to claim 18, wherein the treated object stands on a fixed platform in the center between the two flat-film sounders, and the cardiac shock wave convergent means moves forward and backward so as to fully scan every cubic millimeter of the whole treated object.

22. A method for using a cardiac shock wave medical instrument according to claim 10, comprising the following steps:
applying two contact microphones at diagonal positions on two sides of the treated part of the treated object;
pressing slightly the sounder onto the surface of the treated part;
controlling the full-audio range amplifier and the super-broad audio range sounder by the centralized production control unit, so as to produce a cardiac shock wave with the same frequencies, wavelengths and volumes as those of the treated object's cardiac shock wave; and
directly converging the external cardiac shock wave with the internal cardiac shock wave coming from the treated object's veins and bones to a focus so as to kill germs and cancer effectively at the focus.

23. The method for using a cardiac shock wave medical instrument according to claim 22, wherein the working time of the sounder is adjusted correspondingly based on the depth and density of the treated part in the treated object.

24. The method for using a cardiac shock wave medical instrument according to claim 22, wherein the sounder is turned on and off several times or as many times as deemed necessary, and each time the sounder is on for four to ten minutes or as long as deemed necessary.
